(19) United States
(12) Patent Application Publication
(10) Pub. No.: US 2021/0012214 A1
(43) Pub. Date: Jan. 14, 2021

(54) LEARNING APPARATUS, LEARNING METHOD, AND COMPUTER-READABLE RECORDING MEDIUM

(71) Applicant: NEC Corporation, Minato-ku, Tokyo (JP)

(72) Inventor: Manabu NAKANOYA, Tokyo (JP)

(73) Assignee: NEC Corporation, Minato-ku, Tokyo (JP)

(21) Appl. No.: 16/982,781

(22) PCT Filed: Mar. 26, 2019
(86) PCT No.: PCT/JP2019/012984

§ 371 Date: Sep. 21, 2020

(30) Foreign Application Priority Data
Mar. 29, 2018 (JP) 2018-066057

(51) Int. Cl. G06N 5/00; G06N 20/00; G06K 9/62

(52) U.S. Cl. CPC G06N 5/003; G06K 9/6262; G06K 9/6261; G06N 20/00

(57) ABSTRACT

Provided is a learning apparatus 10 including a feature amount generation unit 11 configured to generate a feature amount based on learning data, a division condition generation unit 12 configured to generate a division condition in accordance with the feature amount and a complexity requirement that indicates the number of feature amounts, a learning data division unit 13 configured to divide the learning data into groups based on the division condition, a learning data evaluation unit 14 configured to evaluate a significance of each division condition by using a pre-division group and a post-division group; and a node generation unit 15 configured to, if there is a significance in the division condition of the pre-division and post-division groups, generate a node of a decision tree relating to the division condition.

### TECHNICAL FIELD

The present invention relates to a learning apparatus, a learning method that are for learning by decision tree, and, furthermore, relates to a computer-readable recording medium that includes a program recorded thereon for realizing the apparatus and method.

### BACKGROUND ART

In an IT (information technology) system, management and changing of the system configuration are broadly divided into three phases. Management and changing of the system configuration are performed in each of the three phases, and realized by repeating tasks (1) (2) and (3) shown below.

(1) Task of grasping the system configuration. (2) Task of defining change requirements. (3) Task of generating operation procedures for changing the system configuration that is currently operating to the system derived from (1) and (2), and executing the generated operation procedures.

However, among these three tasks, the task (3) consumes a lot of man-hours. In view of this, technologies for reducing such man-hours have been proposed.

As a related technology, Patent Document 1 discloses a technology according to which operation procedures used for changing a system are generated by defining operation states of elements constituting the system and restrictions between the operation states.

Patent Document 2 discloses a technology for expressing the state of components and restriction relationships with a state transition diagram.

Patent Document 3 discloses a technique according to which interaction between parameters is verified before learning a decision tree so as to discriminate parameters that appear to have dependency from parameters that do not, and narrow down parameter sets to serve as division condition candidates for the division condition.

Non-Patent Document 1 and Patent Document 2 disclose software tools for automating operation procedures. According to the software tools, a state after changing the system or the operation procedures are input as definition information, and the system is changed and configured automatically.

Non-Patent document 3 and Non-Patent document 4 disclose technologies in which reinforcement learning is used for deriving an optimal change procedure or change parameters by actually trying, evaluating and learning various combinations of the resources of server apparatus (e.g. CPU (Central Processing Unit), memory allocation amount) or applications.

### LIST OF RELATED ART DOCUMENTS

### Patent Document

Patent Document 1: Japanese Patent Laid-Open Publication No. 2015-215885

Patent Document 2: Japanese Patent Laid-Open Publication No. 2015-215887

Patent Document 3: Japanese Patent Laid-Open Publication No. 2005-063353

### Non-Patent Document

Non-Patent Document 1: “Puppet”[online], [retrieved on Jan. 19, 2017], Internet <URL:https://puppet.com/>

Non-Patent Document 2: “Ansible”[online], [retrieved on Jan. 19, 2017] Internet <URL:https://ansible.com/>

Non-Patent Document 3: J. Rao, X. Bu, C. Z. Xu and K. Wang, “A Distributed Self-Learning Approach for Elastic Provisioning of Virtualized Cloud Resources,” [online] [retrieved on Jan. 19, 2017] Aug. 30, 2011, IEEE Xplore [retrieved on Jan. 19, 2017], Internet <URL:http://ieeexplore.ieee.org/abstract/document/6005367/>

Non-Patent Document 4: I. J. Jureta, S. Faulkner, Y. Achbany and M. Saerens, “Dynamic Web Service Composition within a Service-Oriented Architecture,” [online], [retrieved on Jan. 19, 2017] Jul. 30, 2007, IEEE Xplore, [retrieved on Jan. 19, 2017], Internet <URL:http://ieeexplore.ieee.org/document/4279613/>

### SUMMARY OF INVENTION

### Problems to be Solved by the Invention

However, it is only execution of operation procedures that the software tool for automating operation procedures disclosed in Non-Patent Document 1 and Non-Patent Document 2 can automate, and generation of operation procedures is not automated.

In view of this, it is conceivable to apply the technology disclosed in Patent Document 1 or Patent Document 2 to Non-Patent Document 1 or Non-Patent Document 2. In other words, information which indicates the operation procedures for changing the system configuration according to the input form of the software tool for automating execution of the operation procedures is generated by using the technology disclosed in Patent Document 1 or Patent Document 2. Also, the generated operation procedures are applied to the technology disclosed in Non-Patent Document 1 or Non-Patent Document 2 to automate processing from generation of the operation procedures to execution of the operation procedures.

However, in the technologies disclosed in Patent Document 1 and Patent Document 2, since it is necessary to manually perform, in advance, (1) the task of grasping the system configuration and (2) the task of defining change requirements, there is a problem that a lot of man-hours are consumed.

In view of the above-described problems, it is conceivable to use the technology disclosed in Non-Patent Document 3 or Non-Patent Document 4. In other words, it is conceivable to derive the operation procedures and parameters by actually trying, evaluating and learning the combinations of resources (e.g., CPU, memory allocation amount) of the server apparatus or applications in various patterns.

However, the above-described automation using reinforcement learning disclosed in Non-Patent Document 3 and Non-Patent Document 4 differs from the approach in which dependency between constituent elements in the system is directly handled such as disclosed in Patent Document 1 and Patent Document 2, and it is the favorability of a specific control content in a state of a given system that is to be evaluated and learned. The control content is defined by, for example, an observable value such as a response speed of the system.

Accordingly, since learning can be executed simply by means for observing the state of the system and an executable control set being input, reinforcement learning can be comparatively easily applied. However, in reinforcement learning, it is not generally possible to read the relationship with respect to behaviors between the constituent elements such as dependency from the learning result. Accordingly, it is difficult to reuse the learning result for other control tasks.

In view of this, as a solution for these problems, it is conceivable to apply so-called function approximation to reinforcement learning. Function approximation in reinforcement learning involves deriving an approximation function with which information indicating favorability with respect to specific controls obtained as a result of learning can be predicted from more abstract conditions. In other words, it involves learning an approximation function that enables prediction from abstract conditions.

Originally, the above-described solution is a technique that has been developed in fields such as robot control for handling control patterns in a finite set by mapping an infinite set to the finite set, because it is impossible to manage all the control patterns in the storage region of a computer when handling control of consecutive amounts (options are infinitely present). Also, according to the above-described solution, it is possible not only to solve the problem regarding the storage region, but also to improve the versatility of learning results by appropriately abstracting broad and diverse options.

Approximation functions used in function approximation need to be selected according to characteristics of the approximation target and the object of approximation. Examples of typical functions include a linear polynomial expression, a neural network, and a decision tree.

However, in terms of predicting the quality of the design and control of the system from the contents of the design or control, function approximation using a decision tree can be conceived as one effective approximate technique. As a reason for that, first, there is dependency between the parameters. In other words, an optimal value of one parameter will be a different value depending on a value of another parameter. Also, another reason is that non-linear behaviors can be handled. This is because a subtle difference in the set values significantly influences favorability. Furthermore, this is also because interpretability of the generated function is excellent. In other words, this is because a person can evaluate whether the function accurately expresses the control characteristics.

Representative examples of decision tree learning include C4.5, CART (Classification And Regression Trees), and CHAD (Chi-squared Automatic Interaction Detection). These are characterized in that indices used when selecting a division condition of the tree are different for each type of decision tree learning. For example, in C4.5, a division condition is adopted such that data divided based on the division condition reduces entropy compared to data before the division.

A division condition generated through decision tree learning is expressed by a logical expression defined by a single parameter relating to design, control, or the like. This will be explained in more detail below. In the case of a task for optimizing throughput of an application server by adjusting two parameters such as the communication band and the number of CPU cores, the division condition relating to a node of the learned decision tree is conceivably “communication band<10 Mbps”, “number of CPUs>1”, or the like, for example.

Furthermore, if a parameter depends on another parameter, a division condition relating to the parameter on which that parameter depends is adopted at the division destination of the division condition. For example, if “communication band≥10 Mbps”, the number of CPU cores bottlenecks. Furthermore, in the case of a system in which the number of CPU cores is not affected by the throughput, the division condition “communication band<10 Mbps” is set at the vertex node of the decision tree, and the division condition relating to the number of CPU cores is defined at the node at the division destination.

However, in decision tree learning, since the division condition is determined by evaluating how the learning data is appropriately classified for each single parameter, if there is dependency between multiple parameters, division conditions are not appropriately set in some cases. For example, if a single parameter such as memory size is a control target in addition to the above-described parameters such as communication band and the number of CPU cores, the division condition cannot be appropriately set. Specifically, if memory size is a parameter that apparently most affects the throughput, a division condition relating to the memory size is adopted.

As a result, the divided learning data is segmented by the division condition based on memory size, and it is not assured that, in each piece of segmented learning data, the division condition based on the dependency of the communication band and the number of CPU cores as described above is derived. This problem is notable when the substance of the dependency between the parameters is an exclusive logical sum.

FIG. 1 is a diagram showing an example of learning data. “A”, “B”, “C” and “D” shown in FIG. 1 indicate parameters (True: 1, False: 0 binary values). “Y” indicates values to be approximated (predicted values). Specifically, the predicted value Y is a value obtained by adding uniform random numbers in the [0, 1] section to a real value obtained by multiplying the exclusive logical sum (True: 1, False: 0) of the parameters A and B by 10. Note that parameters C and D are parameters that do not actually affect prediction at all. Note that ids “1” to “8” are identification numbers given to respective rows each including the parameters A to D and the predicted value Y.

Accordingly, it is ideal that the decision tree generated by using the learning data shown in FIG. 1 is a decision tree such as shown in FIG. 2, in which the parameters C and D are not included in the division condition. FIG. 2 is a diagram showing an example of an ideal decision tree. However, the decision tree generated by using existing decision tree learning is a decision tree such as shown in FIG. 3. FIG. 3 is a diagram showing an example of a decision tree generated by using existing decision tree learning.

Since evaluation is performed with a single parameter in existing decision tree learning, compared to the decision tree shown in FIG. 2, the decision tree shown in FIG. 3 includes unnecessary division conditions, and therefore a decision tree having a low prediction accuracy is generated. In other words, a complex decision tree is generated in which essential division conditions are not applied to the entire tree.

Specifically, although the parameter C does not affect the predicted value Y, the parameter C is most highly correlated with the predicted value, and thus is the uppermost division condition. For this reason, although a decision tree indicating the exclusive logical sum of the parameters A and B is generated in the partial tree shown on the left side (False: C≠1) of FIG. 3, a decision tree indicating the exclusive logical sum of the parameters A and B is not generated in the partial tree shown on the right side (True: C=1) of FIG. 3.

In view of this, it is conceivable to use the technique of Patent Document 3. In Patent Document 3, interaction between parameters is verified before learning a decision tree so as to discriminate parameters that appear to have dependency from parameters that do not, and narrow down parameter sets to serve as division condition candidates for the division condition.

However, an object of Patent Document 3 is to stabilize the quality of the parameters before learning the decision tree, rather than solve the above-described problems.

An example object of the present invention is to provide a learning apparatus, a learning method, and a computer-readable recording medium according to which the prediction accuracy of a decision tree is improved.

### Means for Solving the Problems

In order to achieve the above-described object, a learning apparatus according to an example aspect of the present invention includes:

a feature amount generation unit configured to generate a feature amount based on learning data;

a division condition generation unit configured to generate a division condition in accordance with the feature amount and a complexity requirement that indicates the number of feature amounts;

a learning data division unit configured to divide the learning data into groups based on the division condition;

a learning data evaluation unit configured to evaluate a significance of each division condition by using a pre-division group and a post-division group; and

a node generation unit configured to, if there is a significance in the division condition of the pre-division and post-division groups, generate a node of a decision tree relating to the division condition.

Furthermore, in order to achieve the above-described object, a learning method according to an example aspect of the invention includes:

(a) a step of generating a feature amount based on learning data;

(b) a step of generating a division condition in accordance with the feature amount and a complexity requirement that indicates the number of feature amounts;

(c) a step of dividing the learning data into groups based on the division condition;

(d) a step of evaluating a significance for each division condition by using a pre-division group and a post-division group; and

(e) a step of, if there is a significance in the division condition of the pre-division and post-division groups, generating a node of a decision tree relating to the division condition.

Furthermore, in order to achieve the above-described object, a computer-readable recording medium according to an example aspect of the present invention includes a program recorded thereon, the program including instructions that cause a computer to carry out:

(a) a step of generating a feature amount based on learning data;

(b) a step of generating a division condition in accordance with the feature amount and a complexity requirement that indicates the number of feature amounts;

(c) a step of dividing the learning data into groups based on the division condition;

(d) a step of evaluating a significance for each division condition by using a pre-division group and a post-division group; and

(e) a step of, if there is a significance in the division condition of the pre-division and post-division groups, generating a node of a decision tree relating to the division condition.

### Advantageous Effects of the Invention

As described above, according to the invention, it is possible to improve the prediction accuracy of a decision tree.

### BRIEF DESCRIPTION OF THE DRAWINGS

FIG. 1 is a diagram showing an example of learning data.

FIG. 2 is a diagram showing an example of an ideal decision tree.

FIG. 3 is a diagram showing an example of a decision tree generated by using existing decision tree learning.

FIG. 4 is a diagram showing an example of a learning apparatus.

FIG. 5 is a diagram showing an example of a system including the learning apparatus.

FIG. 6 is a diagram showing an example of division conditions with respect to complexity requirements.

FIG. 7 is a diagram showing an example of division results.

FIG. 8 is a diagram showing an example of evaluation results.

FIG. 9 is a diagram showing an example of evaluation results.

FIG. 10 is a diagram showing an example of operations of learning data.

FIG. 11 is a diagram showing an example of a computer that realizes the learning apparatus.

### EXAMPLE EMBODIMENTS

### Example Embodiment

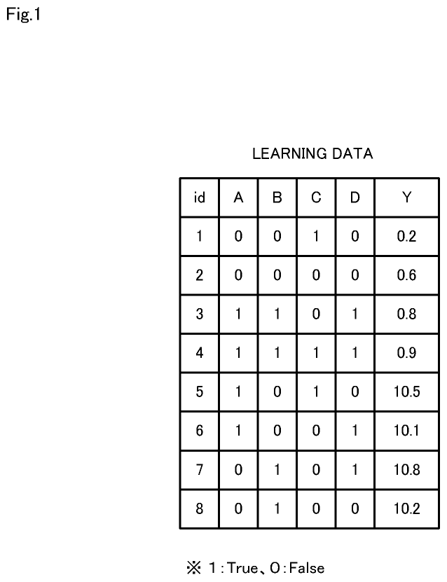

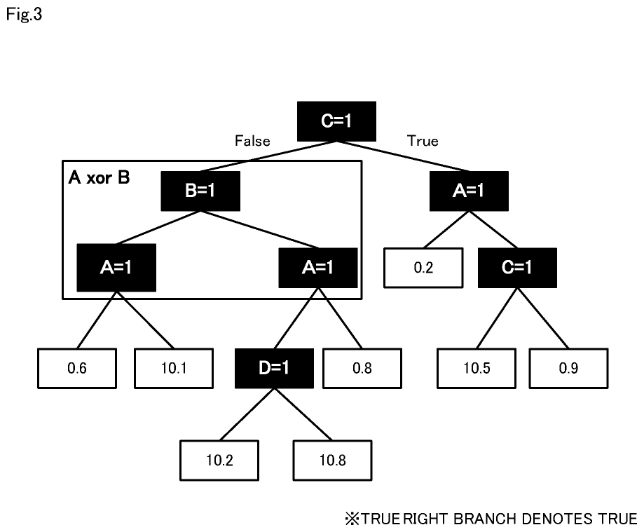

Hereinafter, an example embodiment of the invention will be described with reference to FIG. 1 to FIG. 11.

[Apparatus Configuration]

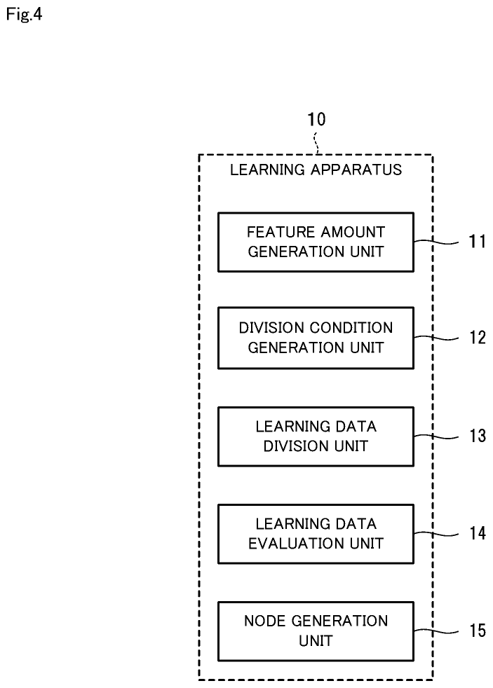

First, the configuration of the learning apparatus 10 according to the present example embodiment will be described using FIG. 4. FIG. 4 is a diagram showing an example of the learning apparatus.

As shown in FIG. 4, the learning apparatus 10 is an apparatus for improving the prediction accuracy of a decision tree. The learning apparatus 10 includes a feature amount generation unit 11, a division condition generation unit 12, a learning data division unit 13, a learning data evaluation unit 14, and a node generation unit 15.

Of these, the feature amount generation unit 11 generates a feature amount based on learning data. The division condition generation unit 12 generates a division condition in accordance with feature amounts and a complexity requirement that indicates the number of feature amounts. The learning data division unit 13 divides learning data into groups based on the division condition. The learning data evaluation unit 14 evaluates the significance of each division condition by using a pre-division group and a post-division group. The node generation unit 15, if a division condition has a significance in the pre-division and post-division groups, generates a node of a division condition decision tree related to the division condition.

As described above, in the present example embodiment, learning data is divided into groups based on the division condition generated according to a feature amount and a complexity requirement, and the significance of each division condition is evaluated by using a pre-division group and a post-division group. Then, if a division condition has a significance in the pre-division and post-division groups, a node of a division condition decision tree related to the division condition is generated. In this manner, it is possible to generate a decision tree having a high prediction accuracy that does not include unnecessary division conditions. In other words, it is possible to generate a decision tree that applies essential division conditions.

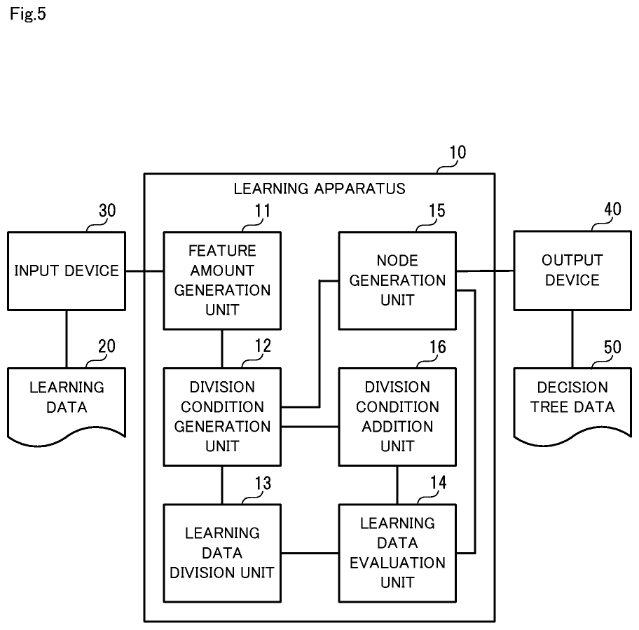

Next, the configuration of the learning apparatus 10 according to the present example embodiment will be illustrated in more detail using FIG. 5. FIG. 5 is a diagram showing an example of a learning system including the learning apparatus.

As shown in FIG. 5, the learning apparatus 10 of the present example embodiment includes the feature amount generation unit 11, the division condition generation unit 12, the learning data division unit 13, the learning data division unit 13, the learning data evaluation unit 14, the node generation unit 15, and a division condition addition unit 16.

Also, in FIG. 5, in addition to the learning apparatus 10, the system includes an input device 30 for inputting learning data 20 to the learning apparatus 10 and an output device 40 for outputting decision tree data 50 generated by the learning apparatus 10. The learning data 20 is data that expresses design rules and is to be input to the system for generating a decision tree.

After acquiring learning data 20 via the input device 30, the feature amount generation unit 11 generates a feature amount (abstract feature amount) that is an element of a division condition based on the learning data 20. Thereafter, the feature amount generation unit 11 converts the learning data 20 based on the generated feature amount.

Specifically, in a case where the learning data shown in FIG. 1 is the learning data after conversion, the parameters A, B, C, and D are feature amounts (abstract feature amounts), and the values in column A to column D each indicate an evaluation value of the original learning data relating to the feature amount. In FIG. 1, it is assumed that the learning data before conversion that corresponds to the learning data in the first row is “the number of CPUs of the server apparatus M: 1”, “the number of CPUs of the server apparatus N: 3”, “the number of CPUs of the server apparatus N: 2”, and “the communication band of the server apparatus N: 1”, and the abstract feature amount A is “the number of CPUs of the server apparatus M >the number of CPUs of the server apparatus N”. In this case, since the logical expression shown by the feature amount A is not satisfied (1<3), the learning data acquires the evaluation value False (0) as the evaluation value of the feature amount A. Note that the communication band “2” of the above-described server apparatus M and the communication band “1” of the server apparatus N indicate the numbers assigned to the communication bands.

In this manner, the feature amount A obtained by comparing the number of CPUs of the server apparatuses is an example indicating a relative relationship between the parameters rather than a specific design value. Accordingly, based on this concept, it is possible to evaluate not only the number of CPUs, but also various designs and parameters such as an IP address, a communication band, and a memory allocation number with the relative relationship. Note that the predicted value Y is the same as the original learning data and is not converted.

The division condition generation unit 12 generates a division condition (specific division condition) in accordance with the feature amount generated based on learning data and a complexity requirement that has been designated. The complexity requirement indicates the number of feature amounts used in a single division condition, and the initial value is 1. Also, when the complexity is increased in a stepwise manner, a maximum value is also set for the complexity condition. For example, the maximum value is conceivably set to 2.

Also, with respect to the specific division conditions, if the complexity requirement is 1, the division conditions of the learning data shown in FIG. 1 are the four division conditions A=True (1)/B=True (1)/C=True (1)/D=True (1). If the complexity requirement is 2, the division condition is a logical expression including two feature amounts.

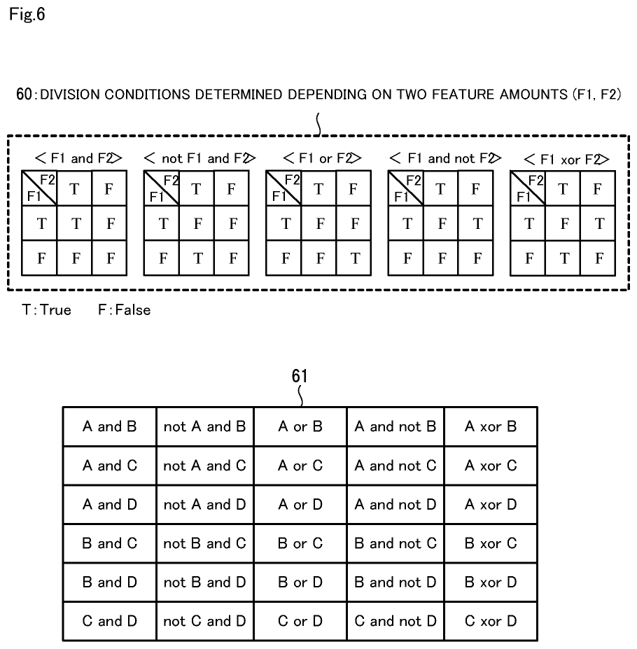

FIG. 6 is a diagram showing division conditions with respect to complexity requirements. In FIG. 6, division conditions 61 generated with respect to the learning data in FIG. 1 if the complexity requirement is 2 (division conditions 60 in FIG. 6). In other words, 30 patterns (4C2×5 patterns) of division conditions 61 shown in FIG. 6 are generated by selecting two feature amounts out of the feature amounts A, B, C, and D shown in FIG. 1, and applying five conditions (F1 and F2, not F1 and F2, F1 or F2, F1 and not F2, F1 xor F2) shown in the division conditions 60 to the two feature amounts.

Furthermore, if the complexity requirement is three or more, logical expressions including the feature amounts of the number of complexity requirements are generated. Note that in the initial operation, according to the initial value of the complexity requirement, the above-described four division conditions A=True (1)/B=True (1)/C=True (1)/D=True (1) are generated.

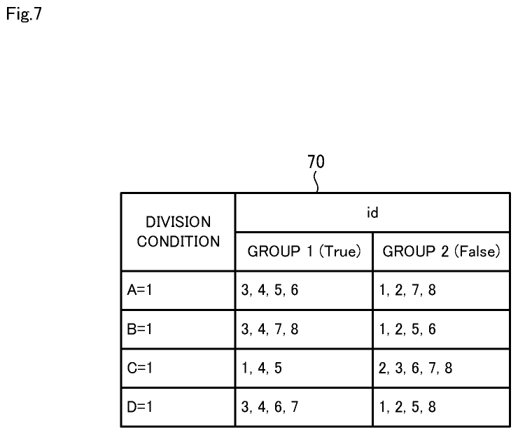

The learning data division unit 13 divides the learning data according to the division condition after acquiring the learning data and the division conditions. In the division of learning data, for example, in a case where the learning data shown in FIG. 1 is divided according to the division conditions A=True (1)/B=True (1)/C=True (1)/D=True (1) having the complexity requirement of 1, division results 70 such as shown in FIG. 7 are obtained. FIG. 7 is a diagram showing an example of division results.

After acquiring a division result, the learning data evaluation unit 14 evaluates how appropriately the division result has divided the learning data. The evaluation is performed by evaluating whether there is a statistically significant difference in the variance of the predicted values between the pre-division and post-division groups. In other words, an equal variance test is performed on the pre-division and post-division groups, and if a null hypothesis that the variance is equal before and after division can be rejected at a significance level calculated by using a significance level that is a preset reference, the division condition is considered to be an effective division condition and is set as the division condition of a branch of the decision tree.

Note that in a case of a binary tree based on a single logical expression as described above, two post-division groups are generated, and therefore the equal variance tests are performed on the one pre-division group and the two post-division groups, and if either of the test results is significant, the division condition thereof is considered to be effective.

Also, if a plurality of effective division conditions are detected, the division condition having the minimum p value in the equal variance test is adopted as the division condition of the actual decision tree. There are several techniques for performing the equal variance test that are different in the hypothesis regarding the probabilistic distribution of the predicted values and the like. For example, if a specific probabilistic distribution is not hypothesized as the predicted value, the Crown-Forsythe test is used. Note that the test method may be selected based on the properties of data to be learned.

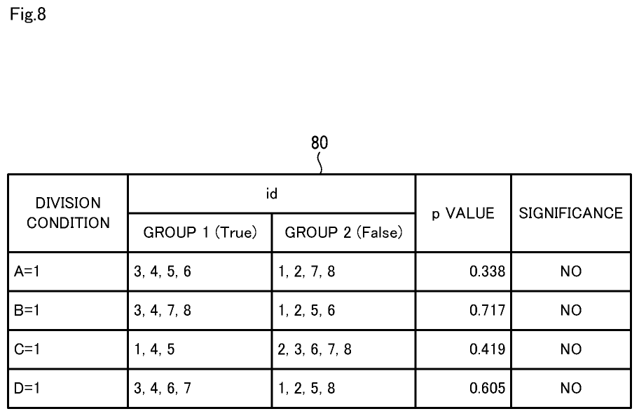

FIG. 8 shows evaluation results based on the division results in FIG. 7. FIG. 8 is a diagram showing an example of evaluation results. The significance level is a value obtained by dividing a significance level that is a preset reference by the number of times of performing the test. In other words, this is a measure for handling an increase in the probability of occurrence of false-positives due to repetition of the equal variance test. In FIG. 8, the significance level that is the reference is 0.01, and the number of times of performing the test is 4×2, and therefore the significance level is 0.01/(4×2)=0.00125. Note that this setting of the significance level is merely an example and is not limited to this.

After acquiring the evaluation results, if there is no significance for all the division conditions (if the p value is greater than or equal to the significance level), the division condition addition unit 16 increases the complexity requirement in order to perform evaluation again with a more complex division condition.

Specifically, in the case of the evaluation results 80 shown in FIG. 8, the division condition addition unit 16 increases the current complexity requirement because there is no significance in all the division conditions. For example, since the current complexity requirement is 1, the complexity requirement is set to 2.

Thereafter, the division condition generation unit 12 re-generates the division conditions in accordance with the updated complexity requirement. Next, the division condition generation unit 12 generates the division conditions shown in FIG. 6 because the complexity requirement is 2. After that, the learning data division unit 13 and the learning data evaluation unit 14 perform division and evaluation on the new division conditions.

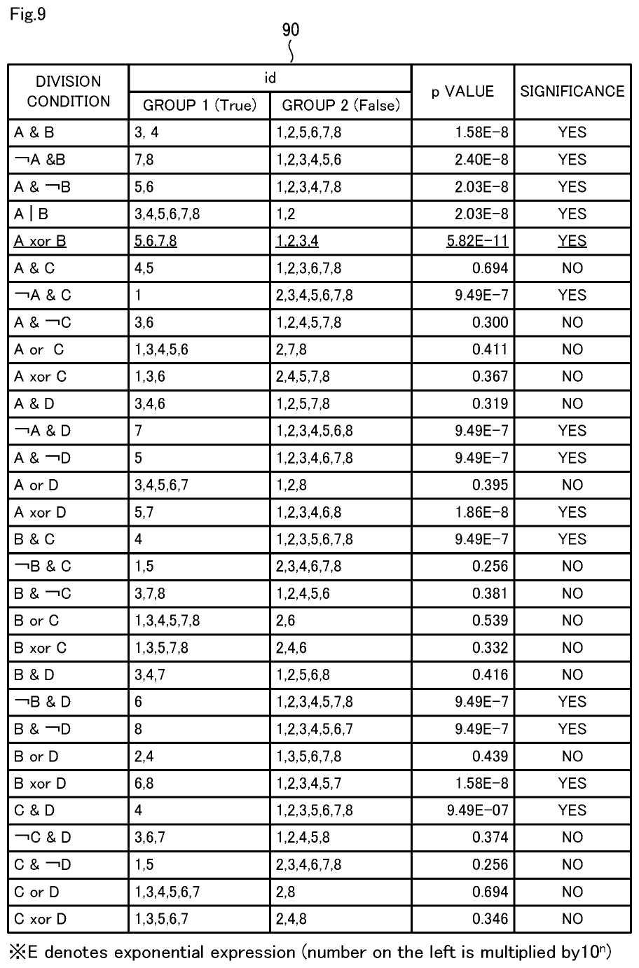

FIG. 9 is a diagram showing an example of evaluation results. In FIG. 9, a plurality of division conditions in which a significance can be recognized are detected, and “A xor B” which is the exclusive logical sum of A and B in which the p value is the minimum division condition is adopted as the optimum division condition.

Also, if the optimum division condition is detected, the learning data evaluation unit 14 sends the optimum division condition to the node generation unit 15.

The node generation unit 15 generates one node of a decision tree associated with the optimum division condition. Also, the node generation unit 15 sends the groups divided with the division condition of the node to the division condition generation unit 12. Note that in the case of a binary tree, the group is divided into two. Next, when receiving the divided groups, the division condition generation unit 12 sets the complexity requirement to 1, which is the initial value. Thereafter, the division condition generation unit 12 continues the above-described processing taking the received groups as new pre-division groups.

Furthermore, in the case where an effective division condition is not detected, and the complexity requirement is repeatedly increased, but the effective division condition is not found even when the maximum requirement is reached, the node generation unit 15 sets the group that could not be divided to the target of node generation as a terminal node. In the case of the evaluation results 90 shown in FIG. 9, even when the division conditions are evaluated on the divided group 1 (True) (5,6,7,8) and the divided group 0 (False) (1,2,3,4) to 2, which is the maximum value of the complexity requirement, a significant division condition is not detected. In that case, generation of the division condition is stopped, and the node generation unit 15 sets those groups to the lowermost layer node (leaf) of the decision tree.

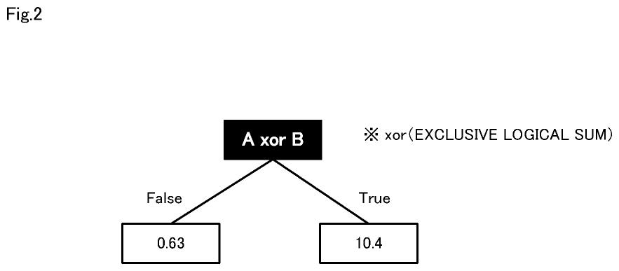

Thereafter, when generation of the lowermost layer node is complete for all the groups, the node generation unit 15 outputs the generated decision tree data 50 via the output device 40. As a result, the decision tree shown in FIG. 2 is output.

[Apparatus Operations]

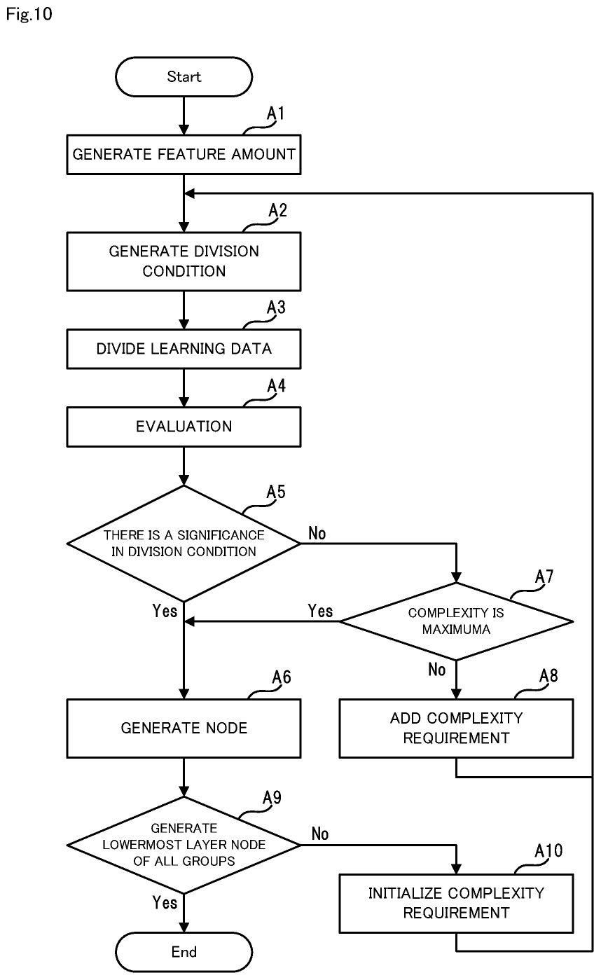

Next, the operations of the learning apparatus according to the present example embodiment will be described using FIG. 10. FIG. 10 is a diagram showing an example of operations of the learning apparatus. In the following description, FIG. 1 to FIG. 9 will be referenced as appropriate. Also, in the present example embodiment, the learning method is performed by operating the learning apparatus. Accordingly, the description of the learning method according to the present example embodiment is replaced with the following description of the operations of the learning apparatus.

In step A1, the feature amount generation unit 11 generates a feature amount that is an element of the division condition (abstract feature amount) based on the acquired learning data 20. Thereafter, the feature amount generation unit 11 converts the learning data 20 based on the generated feature amount.

In step A2, the division condition generation unit 12 generates the division condition (specific division condition) in accordance with the feature amount included in the converted learning data and the complexity requirement of the designated division condition. In step A3, after acquiring the learning data and the division condition, the learning data division unit 13 divides the learning data in accordance with the division condition.

In step A4, after acquiring the division result, the learning data evaluation unit 14 evaluates how appropriately the division result has divided the learning data. For example, the learning data evaluation unit 14 evaluates whether there is a statistically significant difference in the variance of predicted values between the pre-division and post-division groups.

In step A5, the learning data evaluation unit 14 determines whether there is a significance in all the division conditions. If there is no significance (step A5: No), in step A7, the division condition addition unit 16 determines whether the complexity requirement is the maximum value.

If there is a significance (step A5: Yes), or if there is no significance and the complexity requirement is the maximum value (step A7: No), in step A6, the node generation unit 15 generates a node of the decision tree associated with the significant division condition.

In step A8, if the complexity requirement is not the maximum value (step A7: No), the division condition addition unit 16 increases the complexity requirement in order to perform re-evaluation with a more complex division condition. Thereafter, with the increased complexity requirement, the processing of steps A2 to A5 is performed again. Note that, if the current complexity requirement is 1, the complexity requirement is set to 2.

In step A9, the node generation unit 15 determines whether or not the lowermost layer nodes have been generated for all the groups. If the lowermost layer nodes for all the groups have been generated (step A9: Yes), this processing ends. If the lowermost layer nodes for all the groups have not been generated (step A9: No), in step A10, the division condition generation unit 12 sets the complexity requirement to 1, which is the initial value. Thereafter, the division condition generation unit 12 newly executes the processing on the divided groups.

[Effects of the Present Example Embodiment]

As described above, according to the present example embodiment, the learning data is divided into groups using the division condition generated in accordance with the feature amount and the complexity requirement. Thereafter, the significance of each division condition is evaluated by using the pre-division group and the post-division group. Then, if there is a significance in division conditions in the pre-division and post-division groups, a node of a division condition decision tree relating to the division condition is generated. By doing so, it is possible to generate a decision tree having a high prediction accuracy that does not include unnecessary division conditions. In other words, it is possible to generate a decision tree that applies essential division conditions.

[Program]

A program according to the example embodiment of the present invention need only be a program that causes a computer to execute steps A1 to A10 shown in FIG. 10. The learning apparatus and the learning method of the present example embodiment can be realized by installing and executing this program in the computer. In this case, the processor of the computer functions and performs processing as the feature amount generation unit 11, the division condition generation unit 12, the learning data division unit 13, the learning data evaluation unit 14, the node generation unit 15, and the division condition addition unit 16.

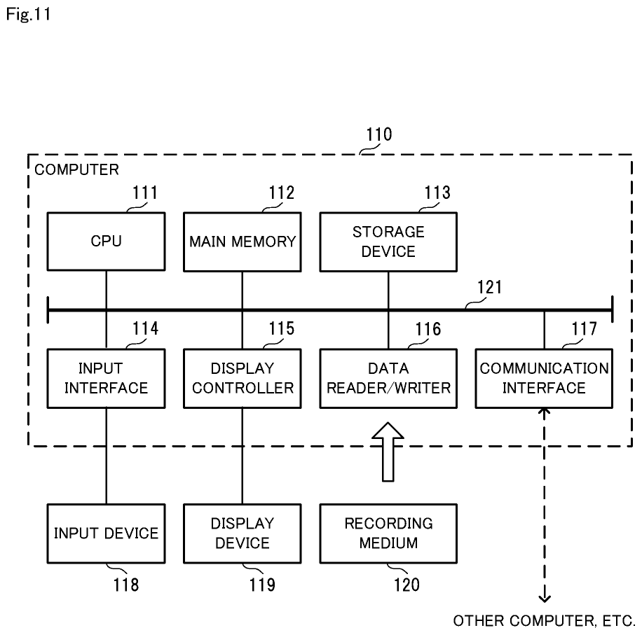

Also, the program of the present example embodiment may also be executed by a computer system constituted by a plurality of computers. In this case, each computer may function as any of the feature amount generation unit 11, the division condition generation unit 12, the learning data division unit 13, the learning data evaluation unit 14, the node generation unit 15, and the division condition addition unit 16.

[Physical Configuration]Here, a computer that realized the learning apparatus by executing the program according to the example embodiment will be illustrated using FIG. 11. FIG. 11 is a diagram showing an example of a computer that realizes the learning apparatus.

As shown in FIG. 11, a computer 110 includes a CPU 111, a main memory 112, a storage device 113, an input interface 114, a display controller 115, a data reader/writer 116, and a communication interface 117. These units are connected so as to be capable of data communication with each other via a bus 121. Note that the computer 110 may include a GPU (Graphics Processing Unit) or an FPGA (Field-Programmable Gate Array) in addition to or in place of the CPU 111.

The CPU 111 executes various kinds of computations by expanding the programs (codes) of the present example embodiment stored in the storage device 113 to the main memory 112, and executing the program in the prescribed order. The main memory 112 is, typically, a volatile storage device such as a DRAM (Dynamic Random Access Memory). Also, the programs of the present example embodiment are provided in a state of being stored in a computer-readable recording medium 120. Note that the programs of the present example embodiment may be programs distributed on the Internet that is connected via the communication interface 117.

Furthermore, specific examples of the storage device 113 include a semiconductor storage device such as a flash memory in addition to a hard disk drive. The input interface 114 mediates data transfer between the CPU 111 and an input device 118 such as a keyboard and mouse. The display controller 115 is connected to a display device 119 and controls display performed by the display device 119.

The data reader/writer 116 mediates data transfer between the CPU 111 and the recording medium 120, and reads out the programs from the recording medium 120 and writes the result of processing in the computer 110 into the recording medium 120. The communication interface 117 mediates data transfer between the CPU 111 and other computers.

Specific examples of the recording medium 120 include a general-purpose semiconductor storage device such as a CF (Compact Flash, registered trademark) and an SD (Secure Digital), a magnetic recording medium such as a flexible disk, or an optical recording medium such as a CD-ROM (Compact Disk Read Only Memory).

Note that, the learning apparatus 1 of the present example embodiment can also be realized by using hardware corresponding to the units rather than a computer in which the programs are installed. Furthermore, a portion of the learning apparatus 1 may be realized by programs, and the remaining portion may be realized by hardware.

[Supplementary Note]

With respect to the above-described example embodiment, the following supplementary notes will be further disclosed. The example embodiment described above can be partially or wholly realized by supplementary notes 1 to 12 described below, but the invention is not limited to the following description.

(Supplementary Note 1)

A learning apparatus including:

a feature amount generation unit configured to generate a feature amount based on learning data;

a division condition generation unit configured to generate a division condition in accordance with the feature amount and a complexity requirement that indicates the number of feature amounts;

a learning data division unit configured to divide the learning data into groups based on the division condition;

a learning data evaluation unit configured to evaluate a significance of each division condition by using a pre-division group and a post-division group; and

a node generation unit configured to, if there is a significance in the division condition of the pre-division and post-division groups, generate a node of a decision tree relating to the division condition.

(Supplementary Note 2)

The learning apparatus according to supplementary note 1, further including:

a division condition addition unit configured to, if there is no significance in all the division conditions in the pre-division and post-division groups, increase the number of feature amounts indicated by the complexity requirement, and cause the division condition generation unit to add the division conditions.

(Supplementary Note 3)

The learning apparatus according to supplementary note 1 or 2, in which

the division condition generation unit generates the division condition by using a logical operator indicating a relationship between the feature amounts.

(Supplementary Note 4)

The learning apparatus according to supplementary note 3, in which

if the number of feature amounts (F1, F2) used in the division condition that is indicated by the complexity requirement is two, the division condition generation unit generates the division condition by using the following conditions:

F1 and F2

not F1 and F2

F1 or F2

F1 and not F2

F1 xor F2

(Supplementary Note 5)

A learning method including:

(a) a step of generating a feature amount based on learning data;

(b) a step of generating a division condition in accordance with the feature amount and a complexity requirement that indicates the number of feature amounts;

(c) a step of dividing the learning data into groups based on the division condition;

(d) a step of evaluating a significance for each division condition by using a pre-division group and a post-division group; and

(e) a step of, if there is a significance in the division condition of the pre-division and post-division groups, generating a node of a decision tree relating to the division condition.

(Supplementary Note 6)

The learning method according to supplementary note 5, further including

(f) a step of, if there is no significance in all the division conditions in the pre-division and post-division groups, increasing the number of feature amounts indicated by the complexity requirement and adding the division conditions.

(Supplementary Note 7)

The learning method according to supplementary note 5 or 6, in which

in the (b) step, the division condition is generated by using a logical operator indicating a relationship between the feature amounts.

(Supplementary Note 8)

The learning method according to supplementary note 7, in which

in the (b) step, if the number of feature amounts (F1, F2) used in the division condition that is indicated by the complexity requirement is two, the division condition is generated by using the following conditions:

F1 and F2

not F1 and F2

F1 or F2

F1 and not F2

F1 xor F2

(Supplementary Note 9)

A computer readable recording medium that includes a program recorded thereon, the program including instructions that causes a computer to carry out:

(a) a step of generating a feature amount based on learning data;

(b) a step of generating a division condition in accordance with the feature amount and a complexity requirement that indicates the number of feature amounts;

(c) a step of dividing the learning data into groups based on the division condition;

(d) a step of evaluating a significance for each division condition by using a pre-division group and a post-division group; and

(e) a step of, if there is a significance in the division condition of the pre-division and post-division groups, generating a node of a decision tree relating to the division condition.

(Supplementary Note 10)

The computer-readable recording medium according to supplementary note 9, in which the program further includes an instruction that causes a computer to carry out:

(f) a step of, if there is no significance in all the division conditions of the pre-division and post-division groups, increasing the number of feature amounts indicated by the complexity requirement and adding the division conditions.

(Supplementary Note 11)

The computer-readable recording medium according to supplementary note 9 or 10, in which

in the (b) step, the division condition is generated by using a logical operator that expresses a relationship between the feature amounts.

(Supplementary Note 12)

The computer-readable recording medium according to supplementary note 11, in which

in the (b) step, if the number of feature amounts (F1, F2) used in the division condition indicated by the complexity requirement is two, the division condition is generated by using the following conditions:

F1 and F2

not F1 and F2

F1 or F2

F1 and not F2

F1 xor F2

Although the invention of the present application has been described above with reference to an example embodiment, the invention is not limited to the example embodiment described above. Various modifications apparent to those skilled in the art can be made to the configurations and details of the invention within the scope of the invention.

This application claims priority from Japanese Patent Application No. 2018-066057, filed Mar. 29, 2018, and the entire content thereof is hereby incorporated by reference herein.

### INDUSTRIAL APPLICABILITY

As described above, according to the present invention, the prediction accuracy of a decision tree can be improved. The present invention is usable in fields in which it is necessary to improve the prediction accuracy of a decision tree.

### LIST OF REFERENCE SIGNS

10 Learning apparatus

11 Feature amount generation unit

12 Division condition generation unit

13 Learning data division unit

14 Learning data evaluation unit

15 Node generation unit

16 Division condition addition unit

20 Learning data

30 Input device

40 Output device

50 Decision tree data

110 Computer

111 CPU

112 Main memory

113 Storage device

114 Input interface

115 Display controller

116 Data reader/writer

117 Communication interface

118 Input device

119 Display device

120 Recording medium

121 Bus

What is claimed is:

1. A learning apparatus comprising:
a feature amount generation unit configured to generate a feature amount based on learning data;
a division condition generation unit configured to generate a division condition in accordance with the feature amount and a complexity requirement that indicates the number of feature amounts;
a learning data division unit configured to divide the learning data into groups based on the division condition;
a learning data evaluation unit configured to evaluate a significance of each division condition by using a pre-division group and a post-division group; and
a node generation unit configured to, if there is a significance in the division condition of the pre-division and post-division groups, generate a node of a decision tree relating to the division condition.

2. The learning apparatus according to claim 1, further comprising:
a division condition addition unit configured to, if there is no significance in all the division conditions in the pre-division and post-division groups, increase the number of feature amounts indicated by the complexity requirement, and cause the division condition generation unit to add the division conditions.

3. The learning apparatus according to claim 1 wherein
the division condition generation unit generates the division condition by using a logical operator indicating a relationship between the feature amounts.

4. The learning apparatus according to claim 3, wherein
if the number of feature amounts (F1, F2) used in the division condition that is indicated by the complexity requirement is two, the division condition generation unit generates the division condition by using the following conditions:
F1 and F2
not F1 and F2
F1 or F2
F1 and not F2
F1 xor F2.

5. A learning method comprising:
generating a feature amount based on learning data;
generating a division condition in accordance with the feature amount and a complexity requirement that indicates the number of feature amounts;
dividing the learning data into groups based on the division condition;
evaluating a significance for each division condition by using a pre-division group and a post-division group; and
if there is a significance in the division condition of the pre-division and post-division groups, generating a node of a decision tree relating to the division condition.

6. The learning method according to claim 5, further comprising
if there is no significance in all the division conditions in the pre-division and post-division groups, increasing the number of feature amounts indicated by the complexity requirement and adding the division conditions.

7. The learning method according to claim 5, wherein
in the generating a division condition, the division condition is generated by using a logical operator indicating a relationship between the feature amounts.

8. The learning method according to claim 7, wherein
in the generating a division condition, if the number of feature amounts (F1, F2) used in the division condition that is indicated by the complexity requirement is two, the division condition is generated by using the following conditions:
F1 and F2
not F1 and F2
F1 or F2
F1 and not F2
F1 xor F2

9. A non-transitory computer readable recording medium that includes a program recorded thereon, the program including instructions that cause a computer to carry out:
generating a feature amount based on learning data;
generating a division condition in accordance with the feature amount and a complexity requirement that indicates the number of feature amounts;
dividing the learning data into groups based on the division condition;
evaluating a significance for each division condition by using a pre-division group and a post-division group; and
if there is a significance in the division condition of the pre-division and post-division groups, generating a node of a decision tree relating to the division condition.

10. The non-transitory computer-readable recording medium according to claim 9, wherein the program further includes an instruction that causes a computer to carry out:
if there is no significance in all the division conditions in the pre-division and post-division groups, increasing the number of feature amounts indicated by the complexity requirement and adding the division conditions.

11. The non-transitory computer-readable recording medium according to claim 9, wherein
in the generating a division condition, the division condition is generated by using a logical operator that expresses a relationship between the feature amounts.

12. The non-transitory computer-readable recording medium according to claim 11, wherein
in the generating a division condition, if the number of feature amounts (F1, F2) used in the division condition indicated by the complexity requirement is two, the division condition is generated by using the following conditions:
F1 and F2
not F1 and F2
F1 or F2
F1 and not F2
F1 xor F2
